(19) United States
(12) Patent Application Publication
(10) Pub. No.: US 2010/0030657 A1
(43) Pub. Date: Feb. 4, 2010

(54) Factory-Sale In One Manufacturing And Selling Shoes Method And System For Providing Multiple Consumer Choice.

(76) Inventor: Chuan Chuang Chen, Taipei Country (TW)

Correspondence Address: Kan Kuan Chuan, P.O. Box 77-13, Taipei, 11161, TW

(21) Appl. No.: 12/515,047

(22) PCT Filed: Nov. 14, 2007
(86) PCT No.: PCT/CN2007/003220

§ 371 Date: May 15, 2009

Related U.S. Application Data
(60) Provisional application No. 60/866,072, filed on Nov. 16, 2006.

(51) Int. Cl. G06Q 30/00; G06F 17/30; G06Q 20/00; G06Q 50/00; G06F 15/16

(52) U.S. Cl. 705/26; 707/104.1; 709/206; 707/E17.044

(57) ABSTRACT

The present invention provides a business method for selling shoes comprises: providing a site; providing a computer comprising a database storing a plurality of characteristics for designing a shoe at said site; receiving a plurality of target characteristics selected from said database at said site; finishing a shoe in accordance with said target characteristics at said site; providing said shoe for try-on at said site; and receiving a payment for said shoe at said site.

### BACKGROUND OF THE PRESENT INVENTION

1. Field of Invention

The invention relates to a business method, and more particularly to a business method for selling shoes.

2. Description of Related Arts

The conventional shopping for buying shoes is to go to a shoe store to select the preferred ones from the demonstrated shoes. Customers passively accept what the shoe design companies provide for the market. There is no interaction between the customer and shoe design companies.

Therefore, there is a demand to provide a new business method for selling shoes for customers' real needs.

### SUMMARY OF THE PRESENT INVENTION

An object of the present invention is to provide a site to combine the designing, manufacturing, and selling shoes.

Another object of the present invention is to attract customers to buy shoes by showing the manufacturing process.

Accordingly, in order to accomplish the one or some or all above objects, the business method for selling shoes comprises: providing a site; providing a computer comprising a database storing a plurality of characteristics for designing a shoe at said site; receiving a plurality of target characteristics selected from said database at said site; finishing a shoe in accordance with said target characteristics at said site; providing said shoe for try-on at said site; and receiving a payment for said shoe at said site.

One or part or all of these and other features and advantages of the present invention will become readily apparent to those skilled in this art from the following description wherein there is shown and described a preferred embodiment of this invention, simply by way of illustration of one of the modes best suited to carry out the invention. As it will be realized, the invention is capable of different embodiments, and its several details are capable of modifications in various, obvious aspects all without departing from the invention. Accordingly, the drawings and descriptions will be regarded as illustrative in nature and not as restrictive.

### BRIEF DESCRIPTION OF THE DRAWINGS

FIG. 1 is an embodiment to illustrates a flow chat of a shoe-selling business method in accordance with the present invention.

FIG. 2 is an embodiment to illustrates the other flow chat of a shoe-selling business method in accordance with the present invention.

### DETAILED DESCRIPTION OF THE PREFERRED EMBODIMENT

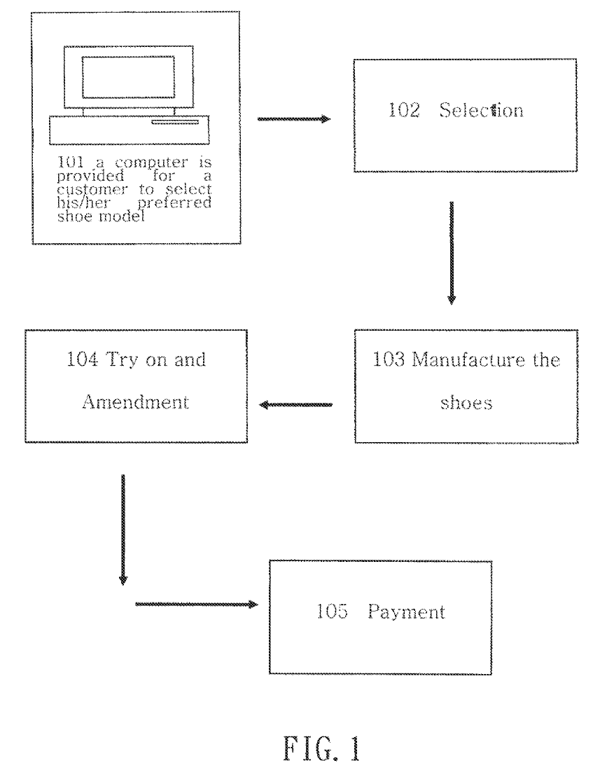

Referring to FIG. 1, it is an embodiment to illustrates a flow chat of a shoe-selling business method in accordance with the present invention. At step 01, a computer is provided for a customer to select his/her preferred shoe model. The computer includes a database storing various selections for design shoes, such as materials, colors, patterns, sizes and so on.

At step 102, a selection including the preferred material, color, pattern, and shoe size is done by the customer via the computer, and sent to the workers through a network connecting the computer. At step 103, the workers manufacture the shoes according to the selection. At step 104, The finished shoes are provided for the customer to try on. If the customer finds there are some flaws in the shoes, the shoes are amended according to the customer's request. At step 105, the customer pays for the shoes. The steps mentioned above are finished at a site.

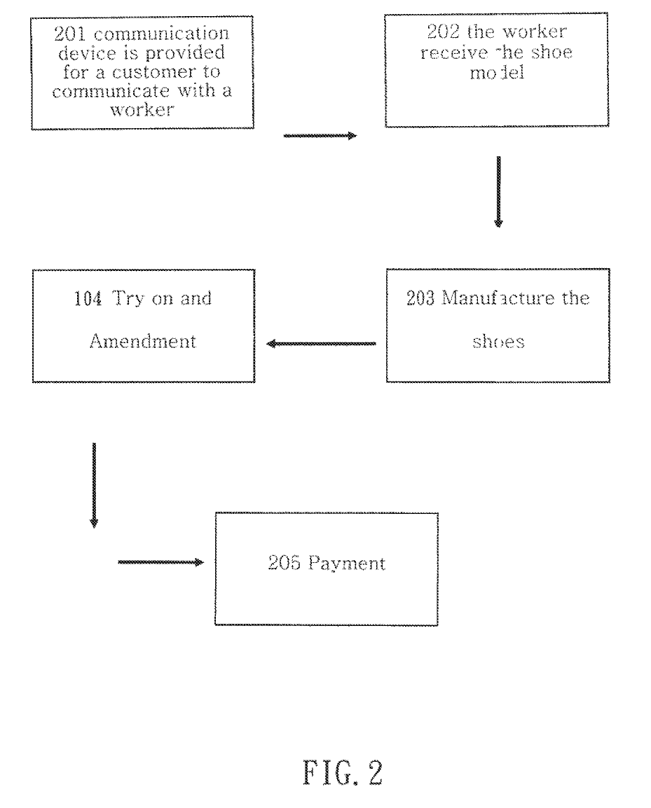

Referring to FIG. 2, it is another embodiment to illustrates a flow chat of a shoe-selling business method in accordance with the present invention. At step 201, communication device is provided for a customer to communicate with a worker. The communication device may include an interphone to talk to the worker and a computer to select and/or send the customer's preferred shoe model.

At step 202, the worker receive the shoe model, including the preferred materials, colors, patterns, and shoe size, from the customer directly or indirectly. The shoe model may be provided by a drawing designed by the customer. The drawing may be finished on a paper or stored in any memory device readable by the computer. At step 103, the workers manufacture the shoes according to the selection. At step 204, The finished shoes are provided for the customer to try on. If the customer finds there are some flaws in the shoes, the shoes are amended according to the customer's request. At step 205, the customer pays for the shoes. The steps mentioned above are finished at a site

To accomplish the steps mentioned above, a site, such as 1 building or any spacious place including exhibiting areas, manufacturing areas, amending areas, fitting areas, and cashier areas, is provided. A network is also provided at the site. The network includes some platforms for customers to select their preferred shoe models. The platforms may include monitors with input devices (keyboards, mouse, or just touch screen monitors), scanners, and interphones, or standard PCs, depending on the demands. The network also includes a memory to provide a database storing the selections about materials, colors, patterns, and sizes.

When a customer visit the site and cannot be satisfied by the demonstrated shoes, he/she may access the database to select the ones he/she needs. The database may be built in a memory in the platform, or the customer have to access the database stored in a server through the network. The customer can design his/her preferred shoe model via the platform and send the design through the network to the worker. The worker receives the design ands then the production line in the manufacturing area manufacture the shoes according to the design right away. The production line may be visible for the customer. The customer can see the whole manufacturing process to realize how the work for making shoes.

If there is no appropriate selection in the database for the customer to design his/her shoes, the customer may design by himself/herself and store the design in the media, such as a floppy disk, CD, or flash memory. Or the design may be finished on a paper, and then scanned in a electronic format, such as a PDF file, to store in any media mentioned above. The customer can talk to the worker via the interphone about his/her design about any detail for optimization for the shoes.

After the shoes are finished, the customer can try on the shoes to see if the shoes fit his/her need. If there is any flaw, it can be amended right away. After the customer is satisfied by the production, he/she pays for the production and finishes the shopping process.

One skilled in the art will understand that the embodiment of the present invention as shown in the drawings and described above is exemplary only and not intended to be limiting.

The foregoing description of the preferred embodiment of the present invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terns are meant in their broadest reasonable sense unless otherwise indicated. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A business method for selling shoes at said site, comprising:
providing a site;
providing a computer comprising a database storing a plurality of characteristics for designing a shoe at said site;
receiving a plurality of target characteristics selected from said database at said site;
finishing a shoe in accordance with said target characteristics at said site;
providing said shoe for try-on at said site; and
receiving a payment for said shoe at said site.

2. The business method according to claim 1, wherein said characteristics comprises material, color, shoe pattern and shoe size.

3. A business method for selling shoes, comprising:
providing a site;
providing an electronic communication device for a first person and a second person at said site;
said second person receiving a design of a shoe from said first person through said electronic communication device at said site;
finishing a shoe in accordance with said design at said site;
providing said shoe for try-on at said site; and
receiving a payment for said shoe at said site.

4. The business method according to claim 3, wherein said electronic communication device comprises a interphone for communication between said first person and said second person.

5. The business method according to claim 3, wherein said electronic communication device comprises a network for sending said design of a shoe.

6. The business method according to claim 5, wherein said computer comprises a database storing a plurality of characteristics for designing a shoe.

7. The business method according to claim 6, wherein said characteristics comprises material, color, shoe pattern and shoe size.
